(19) United States
(12) Patent Application Publication
(10) Pub. No.: US 2026/0186998 A1
(43) Pub. Date: Jul. 2, 2026

(54) DATA SCHEDULING SYSTEM AND METHOD, STORAGE MEDIUM, AND PROGRAM PRODUCT

(71) Applicant: Black Sesame Technologies Co., Ltd., Wuhan (CN)

(72) Inventors: Zhihan Zhang, Shanghai (CN); Hua Wang, Shanghai (CN)

(21) Appl. No.: 19/434,117

(22) Filed: Dec. 29, 2025

(30) Foreign Application Priority Data
Jan. 2, 2025 (CN) 2025100078748

(51) Int. Cl. G06F 13/36

(52) U.S. Cl. CPC G06F 13/36; G06F 2213/40

(57) ABSTRACT

A data scheduling system according to the present disclosure includes: one or more masters configured to determine configuration parameters based on a communication scenario and configured to generate transmission data; a programmable data scheduling circuit configured to receive the configuration parameters and configure an internal circuit structure of the programmable data scheduling circuit based on the configuration parameters, to obtain a configured data scheduler, the configured data scheduler receiving the transmission data; and one or more slaves configured to receive the transmission data scheduled by the configured data scheduler.

### RELATED APPLICATION

This application claims the benefit under 35 U.S.C. § 119(a) of the filing date of Chinese Patent Application No. 2025100078748, filed in the Chinese Patent Office on Jan. 2, 2025. The disclosure of the foregoing application is herein incorporated by reference in its entirety.

### TECHNICAL FIELD

The present disclosure relates to the field of system on chips (SoCs), and in particular, to a data scheduling system and method, a storage medium, and a program product.

### BACKGROUND

In a scenario where a high-speed upper computer, acting as a master, and a low-speed peripheral device, acting as a slave, operate collaboratively within a chip, a data scheduler schedules transmission data. Generally, the data scheduler is applied only to one-to-one node communication and is designed only for specific types of peripheral communication, with internal paths closely dependent on specific instruction content. Once a peripheral type changes, a hardware structure of the data scheduler must be re-customized. Therefore, in face of different communication scenarios with dynamic changes in a number of communication nodes and traffic volumes, a type and a number of the data scheduler are generally required to be modified. As a number and types of nodes increase, a hardware implementation cost of the data scheduler increases significantly.

### SUMMARY

In one aspect of the present disclosure, a data scheduling system is provided, including: one or more masters configured to determine configuration parameters based on a communication scenario and configured to generate transmission data; a programmable data scheduling circuit configured to receive the configuration parameters and configure an internal circuit structure of the programmable data scheduling circuit based on the configuration parameters, to obtain a configured data scheduler, the configured data scheduler receiving the transmission data; and one or more slaves configured to receive the transmission data scheduled by the configured data scheduler.

In some embodiments, the configured data scheduler includes: a data receiving sub-circuit including, based on the configuration parameters, one or more data receiving parts respectively corresponding to the one or more masters, each of the data receiving parts receiving the transmission data from the corresponding master; a transmission buffer sub-circuit including, based on the configuration parameters, one or more transmission storage parts respectively corresponding to the one or more slaves, and configured to buffer the transmission data received from the data receiving sub-circuit into the transmission storage part corresponding to the slave to which the transmission data is to be transmitted, sizes of the one or more transmission storage parts being configured based on traffic volumes of transmission data from different masters to different slaves; and a data scheduling sub-circuit configured to schedule, according to a predetermined rule set based on the configuration parameters, the transmission data buffered in each of the transmission storage parts of the transmission buffer sub-circuit to the slave corresponding to the transmission storage part.

In some embodiments, the configured data scheduler further includes: a readback buffer sub-circuit including, based on the configuration parameters, one or more readback storage parts respectively corresponding to the one or more masters, each of the readback storage parts being configured to buffer readback data to be sent to the master corresponding to the readback storage part by the slave in response to receiving the transmission data; wherein sizes of the one or more readback storage parts are configured based on traffic volumes of readback data from different slaves to different masters.

In some embodiments, the configured data scheduler further includes: an interrupt monitoring sub-circuit configured to monitor events occurring during the scheduling of the transmission data by the configured data scheduler, and generate, in response to monitoring a predetermined event, an interrupt signal and report the interrupt signal to the one or more masters; and the one or more masters include a monitoring response module configured to monitor the interrupt signal reported by the interrupt monitoring sub-circuit of the configured data scheduler, and perform, when the interrupt signal is monitored, processing corresponding to the monitored interrupt signal.

In some embodiments, the interrupt monitoring sub-circuit is further configured to: determine, based on the configuration parameters, whether an interrupt priority of the generated interrupt signal is higher than a predetermined priority; report, in response to the interrupt priority of the generated interrupt signal being higher than the predetermined priority, the generated interrupt signal to the one or more masters; and clear, in response to the interrupt priority of the generated interrupt signal being no higher than the predetermined priority, the generated interrupt signal without reporting the interrupt signal to the one or more masters.

In some embodiments, the configured data scheduler further includes: a security check sub-circuit configured to determine a circuit structure thereof based on the configuration parameters, and check, based on the determined circuit structure, whether an error occurs during operation of the configured data scheduler; and the interrupt monitoring sub-circuit is further configured to generate, in response to monitoring that an error occurs during the operation of the configured data scheduler, an interrupt signal and report the interrupt signal to the one or more masters.

In some embodiments, the security check sub-circuit includes a data check sub-circuit configured to determine a data check algorithm based on the configuration parameters, and check, based on the determined data check algorithm, whether an error occurs during transmission of the transmission data; and the interrupt monitoring sub-circuit is further configured to generate, in response to monitoring that an error occurs during the transmission of the transmission data, an interrupt signal and report the interrupt signal to the one or more masters.

In some embodiments, the transmission buffer sub-circuit is further configured to disable, when a capacity of the transmission data buffered in the transmission buffer sub-circuit reaches a predetermined threshold set based on the configuration parameters, a receiving channel for receiving the transmission data from the data receiving sub-circuit; and the interrupt monitoring sub-circuit is further configured to generate, in response to monitoring that the capacity of the transmission data buffered in the transmission buffer sub-circuit reaches the predetermined threshold, the interrupt signal and report the interrupt signal to the one or more masters.

In some embodiments, the transmission data includes a master identifier, a slave identifier, and a data content part adapted to a slave type; the transmission buffer sub-circuit buffers, based on the slave identifier of the transmission data, the transmission data into the transmission storage part corresponding to the slave identifier; and the readback buffer sub-circuit buffers, based on the master identifier of the transmission data, readback data corresponding to the transmission data into the readback storage part corresponding to the master identifier.

In some embodiments, the transmission data includes a fast transmission flag bit and a priority flag bit; the configured data scheduler determines, based on the fast transmission flag bit, whether to cause the data scheduling sub-circuit to directly acquire the transmission data received by the data receiving sub-circuit, without passing through the transmission buffer sub-circuit; and the data scheduling sub-circuit is further configured to determine, based on the priority flag bit, a priority order of transmission of the transmission data to the slaves.

In another aspect of the present disclosure, a data scheduling method is provided, including: determining configuration parameters based on a communication scenario between masters and slaves; configuring an internal circuit structure of a programmable data scheduling circuit based on the configuration parameters, to obtain a configured data scheduler; and sending the transmission data to the configured data scheduler, to cause the configured data scheduler to schedule the transmission data.

In another aspect of the present disclosure, a non-transitory computer-readable storage medium is provided, having a computer program stored therein, wherein when the computer program is executed by a processor, the data scheduling method above is implemented.

In another aspect of the present disclosure, a computer program product is provided, including a computer program, wherein when the computer program is executed by a processor, the data scheduling method above is implemented.

According to the data scheduling system and method, the storage medium, and the program product in the present disclosure, one or more masters control a programmable data scheduling circuit, and a data scheduler based on a communication scenario is generated. A structure and a function of the programmable data scheduling circuit may be non-volatilely (persistently) programmed according to a communication scenario between masters and slaves, thereby obtaining a data scheduler whose structure and function may be flexibly changed according to an actual requirement. The data scheduling system according to the above embodiments can be easily applied to communication of transmission data from multiple masters to multiple slaves, and can also be applied to various types of slave devices, which prevents large-scale hardware changes for data scheduling each time numbers or types of the masters and the slaves are changed. Therefore, the data scheduler according to the above embodiments can adapt to various communication scenarios, greatly improving versatility. The data scheduling system according to the above embodiments can meet various communication requirements in an efficient, flexible, and low-cost manner, without significantly increasing hardware overhead for data scheduling due to changes in the communication scenario between the masters and the slaves.

### BRIEF DESCRIPTION OF THE DRAWINGS

FIG. 1 is a schematic block diagram of configuration of a data scheduling system according to embodiments of the present disclosure;

FIG. 2 is a schematic block diagram of configuration of a configured data scheduler according to embodiments of the present disclosure;

FIG. 3 is a schematic block diagram of configuration of a data receiving sub-circuit according to embodiments of the present disclosure;

FIG. 4 is a schematic block diagram of configuration of a transmission buffer sub-circuit and a data scheduling sub-circuit according to embodiments of the present disclosure;

FIG. 5 is a schematic diagram of configuration of a readback buffer sub-circuit and a corresponding data transmission path according to embodiments of the present disclosure;

FIG. 6 is a schematic block diagram of configuration of a data check sub-circuit according to embodiments of the present disclosure;

FIG. 7 is a schematic diagram of a data format of transmission data according to embodiments of the present disclosure; and

FIG. 8 is a flowchart of a data scheduling method according to embodiments of the present disclosure.

### DETAILED DESCRIPTION

In a SoC, a data scheduler is configured to perform data scheduling between masters and slaves, in order to establish a physical path for data communication between the masters and the slaves, thereby enabling the masters to control the slaves. For example, inside an ISP chip, a high-speed upper computer schedules transmission data through the data scheduler to a low-speed I2C peripheral, in order to control the low-speed I2C peripheral.

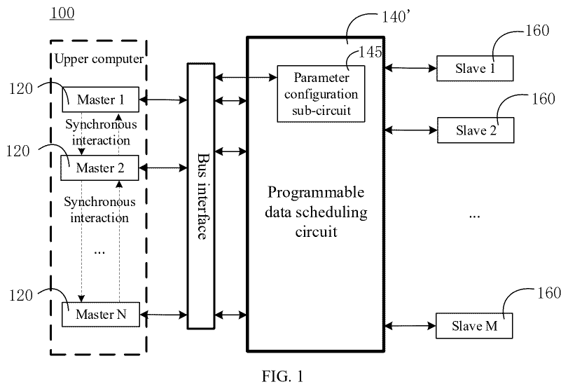

FIG. 1 is a schematic block diagram of configuration of a data scheduling system 100 according to embodiments of the present disclosure. The data scheduling system 100 according to the embodiments of the present disclosure includes: one or more masters 120, a programmable data scheduling circuit 140′, and one or more slaves 160.

The one or more masters 120 are devices or nodes that initiate transmission of data (e.g., instructions). Each master 120 owns an independent physical entity, such as a CPU, and executes software programs stored within it to implement a function of the executed software programs. Each master 120 includes an interface for connecting to the programmable data scheduling circuit 140′. For example, each master 120 is connected to the programmable data scheduling circuit 140′through the respective interface and via a bus interface, such as an advanced high-performance bus (AHB) interface. The software programs run in each master 120 may be the same or different. The one or more masters 120 may also be referred to as upper computers.

The one or more masters 120 are configured to determine configuration parameters based on a communication scenario and configured to generate transmission data. The communication scenario refers to a communication scenario between the one or more masters 120 and the one or more slaves 160, such as numbers of the masters 120 and the slaves 160 participating in communication, device types, a communication manner, and a node traffic volume. The communication manner is, for example, serial communication, parallel communication, or network-based communication. The node traffic volume refers to an amount of data transmitted or received by each device node per unit of time. The transmission data refers to data to be sent to the slaves 160 by the one or more masters 120, such as control instructions and processing parameters. A plurality of configuration parameters are provided, are respectively configured to, for example, indicate numbers of the masters 120 and the slaves 160 participating in communication, device types, a communication manner, and a node traffic volume, and are respectively configured to configure various sub-circuits in the programmable data scheduling circuit 140′.

When the data scheduling system 100 includes a plurality of masters 120, the plurality of masters 120 preferably share a set of bus interfaces to be connected to the programmable data scheduling circuit 140′ (or a configured data scheduler 140). In this case, the plurality of masters 120 interact synchronously and communicate with each other to prevent overwriting or miswriting of the configuration parameters.

The programmable data scheduling circuit 140′ is configured to receive the configuration parameters and configure an internal circuit structure of the programmable data scheduling circuit 140′ based on the configuration parameters, to obtain a configured data scheduler 140. The configured data scheduler 140 receives the transmission data.

Specifically, the programmable data scheduling circuit 140′ includes a parameter configuration sub-circuit 145, which includes, for example, a plurality of control-status registers (CSRs). A CSR is a register configured to control and monitor operation of hardware modules. An internal circuit structure of the programmable data scheduling circuit 140′ is adjusted according to configuration parameters stored in the CSR. The master 120 may read and modify the parameters, to achieve precise control over a behavior of an internal hardware circuit of the programmable data scheduling circuit 140′. The programmable data scheduling circuit 140′ is in communicatively coupled with the one or more masters 120 through a physical interface. The programmable data scheduling circuit 140′ receives the configuration parameters and subsequent transmission data from the master 120 through the physical interface.

The configuration parameters received by the programmable data scheduling circuit 140′ are input to the parameter configuration sub-circuit 145 to construct an actual operating circuit structure of the programmable data scheduling circuit 140′, to form the configured data scheduler 140. The configured data scheduler 140 implements, according to the configuration parameters, a function that the master 120 wants to implement. For example, the master 120 may write the number of masters and/or the number of slaves (node number) as configuration parameters into the parameter configuration sub-circuit 145, and the programmable data scheduling circuit 140′ may adjust, according to the node number, a topological structure or a resource allocation strategy of the system. The master 120 may write estimated traffic volumes of transmission data from different masters to different slaves as configuration parameters into the parameter configuration sub-circuit 145, and the programmable data scheduling circuit 140′ may configure memory and memory partitions according to the estimated traffic volumes. The master 120 may write a scheduling and transmission strategy to the parameter configuration sub-circuit 145, and the programmable data scheduling circuit 140′ may adjust an order and timing of data scheduling and transmission according to the scheduling and transmission strategy. The configured data scheduler 140 receives the transmission data from each master 120 via one or more physical interfaces connected to the master 120. The programmable data scheduling circuit 140′ or the configured data scheduler 140 includes various circuit structures such as gate circuits and memories, providing the transmission data with a physical link for transmission. In specific implementation, the programmable data scheduling circuit 140′ is, for example, an application specific integrated circuit (ASIC), the configuration parameters are loaded, by using a hardware description language, into the ASIC serving as the programmable data scheduling circuit 140′, and the ASIC configures a corresponding circuit structure according to the configuration parameters and loads an algorithm, to obtain the configured data scheduler 140.

It is easy to understand that the parameter configuration sub-circuit 145 is connected to sub-circuits inside the programmable data scheduling circuit 140′ or the configured data scheduler 140, including a data receiving sub-circuit 142, a transmission buffer sub-circuit 144, a data scheduling sub-circuit 146, a data check sub-circuit 147, and a readback buffer sub-circuit 148, which will be described later, in order to configure and non-volatilely program the circuit structure thereof.

The one or more slaves 160 are configured to receive the transmission data scheduled by the configured data scheduler 140.

The one or more slaves 160 are in communication connection with the programmable data scheduling circuit 140′ through a physical interface, and receive, via the physical interface, the transmission data scheduled by the configured data scheduler 140. For example, the configured data scheduler 140 schedules (e.g., sends), according to a destination slave indicated in the transmission data, the transmission data to the corresponding destination slave. The one or more slaves 160 perform a corresponding operation based on the received transmission data. For example, the slave 160 adjusts its own operating state based on the received transmission data, and generates execution results as readback data, ready to be sent back to the master 120.

According to the data scheduling system 100 in the above embodiments, the one or more masters 120 control the programmable data scheduling circuit 140′, and the data scheduler 140 is generated based on a communication scenario. A structure and a function of the programmable data scheduling circuit 140′ may be non-volatilely programmed according to a communication scenario between masters and slaves, thereby obtaining the data scheduler 140 whose structure and function may be flexibly changed according to an actual requirement. The data scheduling system 100 according to the above embodiments can be easily applied to communication of transmission data from multiple masters to multiple slaves, and can also be applied to various types of slave devices, which prevents large-scale hardware changes for data scheduling each time numbers or types of the masters and the slaves are changed. Therefore, the data scheduler 140 according to the above embodiments can adapt to various communication scenarios, greatly improving versatility. The data scheduling system 100 according to the above embodiments can meet various communication requirements in an efficient, flexible, and low-cost manner, without significantly increasing hardware overhead for data scheduling due to changes in the communication scenario between the masters and the slaves.

In some embodiments, the configured data scheduler 140 includes a data receiving sub-circuit 142, a transmission buffer sub-circuit 144, and a data scheduling sub-circuit 146.

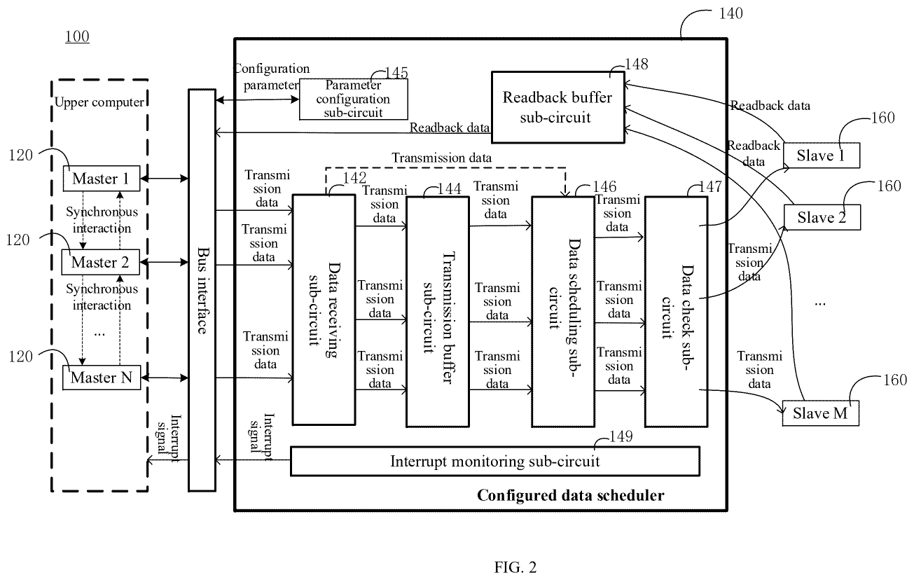

FIG. 2 is a schematic block diagram of configuration of the configured data scheduler 140 according to embodiments of the present disclosure. It is easy to understand that the configured data scheduler 140 is non-volatilely programmed from the programmable data scheduling circuit 140′. Therefore, the configured data scheduler 140 also includes a parameter configuration sub-circuit 145 configured to non-volatilely program the programmable data scheduling circuit 140′into the configured data scheduler 140. The programmable data scheduling circuit 140′ also includes a data receiving sub-circuit 142, a transmission buffer sub-circuit 144, and a data scheduling sub-circuit 146. The data receiving sub-circuit 142, the transmission buffer sub-circuit 144, and the data scheduling sub-circuit 146 of the programmable data scheduling circuit 140′ are configured and non-volatilely programmed based on the configuration parameters received by the parameter configuration sub-circuit 145, to form the data receiving sub-circuit 142, the transmission buffer sub-circuit 144, and the data scheduling sub-circuit 146 of the configured data scheduler 140.

The data receiving sub-circuit 142 includes, based on the configuration parameters, one or more data receiving parts respectively corresponding to the one or more masters 120. Each data receiving part receives the transmission data from the corresponding master.

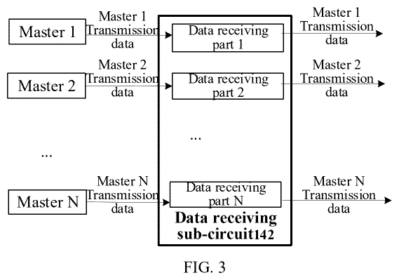

FIG. 3 is a schematic block diagram of configuration of the data receiving sub-circuit 142 according to embodiments of the present disclosure. The data receiving sub-circuit 142 configures an own structure based on the configuration parameters received by the parameter configuration sub-circuit 145. In the configured data scheduler 140, the data receiving sub-circuit 142 includes, based on the number of the masters 120, one or more data receiving parts respectively in one-to-one correspondence to the one or more masters 120. That is, each master 120 respectively corresponds to one data receiving part, and the data receiving part receives the transmission data sent by the master 120. In exemplary implementation, each data receiving part is a physical hardware input port on the configured data scheduler 140, each master 120 separately corresponds to one physical hardware input port and is connected to the physical hardware input port, and each physical hardware input port includes a small amount of buffer space used to buffer the received transmission data. The transmission data sent by the master 120 is received by the configured data scheduler 140 via the corresponding data receiving part.

The transmission buffer sub-circuit 144 is connected to the data receiving sub-circuit 142. The transmission buffer sub-circuit 144 includes, based on the configuration parameters, one or more transmission storage parts respectively corresponding to the one or more slaves 160, and configured to buffer the transmission data received from the data receiving sub-circuit 142 into the transmission storage part corresponding to the slave 160 to which the transmission data is to be transmitted. Sizes of the one or more transmission storage parts are configured based on the traffic volumes of transmission data from different masters to different slaves.

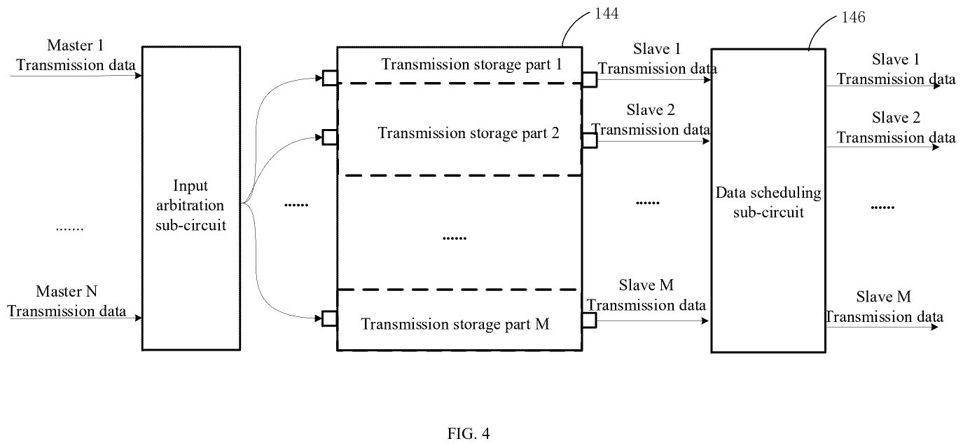

FIG. 4 is a schematic block diagram of configuration of the transmission buffer sub-circuit 144 and the data scheduling sub-circuit 146 according to embodiments of the present disclosure. The transmission buffer sub-circuit 144 configures an own structure based on the configuration parameters received by the parameter configuration sub-circuit 145. In the configured data scheduler 140, the transmission buffer sub-circuit 144 includes, based on the number of the slaves 160, one or more transmission storage parts respectively in one-to-one correspondence to the one or more slaves 160. For example, the transmission buffer sub-circuit 144 is a single memory, such as a single SPRAM. Based on the number of the slaves 160, the memory is partitioned into a plurality of transmission storage parts with contiguous address spaces. The number of the transmission storage parts is consistent with the number of the slaves 160. Each transmission storage part is configured to buffer transmission data destined for the slave corresponding to the transmission storage part. That is, the transmission data is buffered into the corresponding transmission storage parts according to the destination slaves thereof. More specifically, the control logic of each transmission storage part (e.g., each address space) is implemented as first-in-first-out (FIFO). FIFO is a data buffer structure. The transmission data to be sent to a same slave 160 is stored in and retrieved from the transmission storage part corresponding to the slave 160 in chronological order of arrival.

Preferably, after passing through the data reception sub-circuit 142 and before entering the transmission buffer sub-circuit 144, the transmission data further undergoes arbitration by a data arbitration sub-circuit to determine a sequence in which a plurality of pieces of transmission data are written into the transmission buffer sub-circuit 144.

Sizes of the one or more transmission storage parts are configured based on traffic volumes of the transmission data from different masters 120 to different slaves 160. The master 120 estimates sizes of the transmission data, thereby taking traffic volumes of the transmission data from different masters to different slaves as configuration parameters. The transmission buffer sub-circuit 144 divides an internal space thereof into a plurality of transmission storage parts based on the traffic volumes of the transmission data from different masters to different slaves, so that the size of each transmission storage part increases as a traffic volume of transmission data to be received by the slave corresponding thereto increases. That is, a larger storage space is allocated to the transmission storage part corresponding to the slave receiving a higher traffic volume of transmission data, while a smaller storage space is allocated to the transmission storage part corresponding to the slave receiving a lower traffic volume of transmission data.

The data scheduling sub-circuit 146 is connected to the transmission buffer sub-circuit 144. The data scheduling sub-circuit 146 is configured to schedule (e.g., send), according to a predetermined rule set based on the configuration parameters, the transmission data buffered in each of the transmission storage parts of the transmission buffer sub-circuit 144 to the slave 160 corresponding to the transmission storage part.

As described above, the transmission buffer sub-circuit 144 may be implemented as a single memory. Limited by the throughput of the memory, in a scenario where transmission data in a plurality of address spaces (e.g., a plurality of transmission storage parts) is required to be simultaneously sent to the corresponding slaves 160, the data scheduling sub-circuit 146 performs arbitration to determine a sending order of the transmission data. A predetermined rule is a rule used to arbitrate the sending order of the transmission data, which is set according to the configuration parameters determined by the master 120. For example, the predetermined rule may determine the sending order according to priorities in the transmission data, or determine the sending order according to a sequence of arrival of the transmission data at the transmission buffer sub-circuit 144.

More specifically, the data scheduling sub-circuit 146 communicates with each slave 160 via a handshake protocol to schedule (e.g., send) the transmission data buffered in the transmission storage part to the corresponding slave 160. It is easy to understand that the transmission data is transmitted between the data scheduling sub-circuit 146 and the slave 160 through a physical link (e.g., hardware circuit).

According to the data scheduling system 100 in the above embodiments, a specific operating circuit structure of the configured data scheduler 140 is configured and non-volatilely programmed according to the configuration parameters determined by the master 120. The transmission data is transmitted through the data receiving sub-circuit 142 corresponding to the master 120 to the transmission buffer sub-circuit 144 corresponding to the slave 160, realizing mapping of the transmission data received from the master 120 to the address space corresponding to the slave 160, thereby enabling easy application to communication of the transmission data from a plurality of masters 120 to a plurality of slaves 160. In addition, the data scheduling system 100 configures sizes of internal buffer spaces of different paths (e.g., sizes of the plurality of transmission storage parts) according to traffic volumes of the transmission data from different masters 120 to different slaves 160, to respectively buffer transmission data to be sent to different slaves 160, which prevents a requirement for a large number of adjustments to hardware of the data scheduler when inter-node communication traffic changes. Furthermore, the predetermined rule for the transmission data is also set by the master 120, which can maintain the data scheduling system 100 to satisfy an actual requirement.

In some embodiments, the configured data scheduler 140 further includes a readback buffer sub-circuit 148 including, based on the configuration parameters, one or more readback storage parts respectively corresponding to the one or more masters 120. Each readback storage part is configured to buffer readback data to be sent to the master corresponding to the readback storage part by the slave 160 in response to receiving the transmission data. Sizes of the one or more readback storage parts are configured based on traffic volumes of readback data from different slaves to different masters.

When the slave 160 receives transmission data from the master 120, the slave 160 may return readback data for the transmission data. For example, when the transmission data sent by the master 120 to the slave 160 is a control instruction, the slave 160 may return a specific execution state (e.g., successful execution or failed execution) of the control instruction and a corresponding computation result of the slave 160 to the master 120 sending the control instruction thereto. A process in which the slave 160 returns the readback data to the master 120 is also scheduled and transmitted through the configured data scheduler 140.

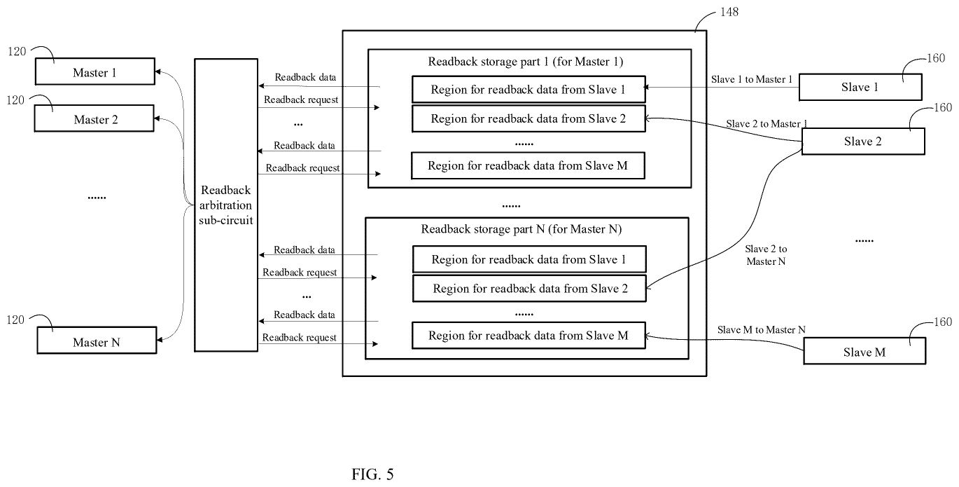

FIG. 5 is a schematic diagram of configuration of the readback buffer sub-circuit 148 and a corresponding data transmission path according to embodiments of the present disclosure. FIG. 3 illustrates that the readback buffer sub-circuit 148 in the configured data scheduler 140 includes a readback storage part 1 to a readback storage part N, and the readback storage parts 1 to N are in one-to-one correspondence to masters 1 to N. The readback buffer sub-circuit 148 may be a memory divided into a plurality of storage parts. Each readback storage part is configured to buffer readback data to be sent to the master 120 corresponding to the readback storage part by the slave 160 in response to receiving the transmission data. More specifically, the slave 160 transmits readback data to the master 120 from which the received transmission data is originated. That is, the slave 160 sends the readback data to the master 120 from which the received data is originated. Accordingly, according to the master 120 to which the data is to be sent, the readback storage part where the readback data is to be buffered is selected. Furthermore, each readback storage part is further divided into a plurality of regions in one-to-one correspondence to the slaves 160, and readback data from different slaves 160 is buffered in different regions of the readback storage part.

When data readback occurs, the slave 160 generates readback data according to the received transmission data. The readback data is then transmitted to the master 120 from which the transmission data received by the slave 160 is originated. The readback data is buffered in the corresponding readback storage part according to the master 120 to which the readback data is to be transmitted. Therefore, a corresponding readback interrupt signal (generated by an interrupt monitoring sub-circuit 149 described later) is reported to the master 120. In response to receiving the readback interrupt signal, the master 120 sends a readback request to the readback buffer sub-circuit 148, and the readback buffer sub-circuit 148 sends readback data to the corresponding master based on the readback request. Limited by a throughput of the readback buffer sub-circuit 148, the configured data scheduler 140 may further include a readback arbitration sub-circuit to arbitrate a sending order of the readback data. An arbitration rules for the readback arbitration sub-circuit may be determined by the configuration parameters determined by the master 120.

Sizes of the one or more readback storage parts are configured based on traffic volumes of readback data from different slaves to different masters. The master 120 estimates sizes of the readback data, thereby taking the traffic volumes of the readback data from different slaves to different masters as configuration parameters. The readback buffer sub-circuit 148 divides an internal space thereof into a plurality of readback storage parts based on the traffic volumes of the readback data from different slaves to different masters, so that the size of each readback storage part increases as a traffic volume of readback data to be received by the master corresponding thereto increases. That is, a larger storage space is allocated to the readback storage part corresponding to the master receiving a higher traffic volume of readback data, while a smaller storage space is allocated to the readback storage part corresponding to the master receiving a lower traffic volume of readback data.

According to the data scheduling system 100 in the above embodiments, the configured data scheduler 140 can rationally schedule the readback data sent by the slave 160 to the master 120 in response to receiving the transmission data. In addition, the data scheduling system 100 configures sizes of internal buffer spaces of different paths (e.g., sizes of the plurality of readback storage parts) according to traffic volumes of the readback data from different slaves 160 to different masters 120, to respectively buffer transmission data to be sent to different masters 120, which prevents contention and conflict when a plurality of readback data streams are simultaneously read back to a same space, and eliminates a need for a large number of adjustments to hardware of the data scheduler due to changes in inter-node communication traffic.

In some embodiments, the configured data scheduler 140 further includes: an interrupt monitoring sub-circuit 149 configured to monitor events occurring during the scheduling of the transmission data by the configured data scheduler 140, and generate, in response to monitoring a predetermined event, an interrupt signal and report the interrupt signal to the one or more masters 120. The one or more masters 120 include a monitoring response module configured to monitor the interrupt signal reported by the interrupt monitoring sub-circuit of the configured data scheduler, and perform, when the interrupt signal is monitored, processing corresponding to the monitored interrupt signal.

Referring to FIG. 2 again, the configured data scheduler 140 further includes an interrupt monitoring sub-circuit 149. The interrupt monitoring sub-circuit 149 monitors operation of the data scheduler 140 in real time. Upon detection of a situation where a specific condition (a predetermined event) is met, an interrupt signal may be generated in real time and reported to the one or more masters 120, so that the masters 120 learn about that a predetermined event occurs in the configured data scheduler 140, thereby performing corresponding processing. The predetermined event is, for example, a specific state of the configured data scheduler 140, such as the occurrence of internal errors in various sub-circuits of the configured data scheduler 140, the generation of readback data, a data check error, a memory capacity exceeding a threshold, or the arrival of a specific time threshold.

The predetermined event may be set for each master 120 based on the configuration parameters. The predetermined event set for each master 120 may be different. For example, some of the masters 120 are not required to pay attention to a specific event, so the master 120 may mask an interrupt signal for the specific event. That is, for the master 120, the predetermined event triggering the interrupt signal does not include the specific event.

The monitoring response module of the one or more masters 120 monitors, in real time, an interrupt signal reported by the configured data scheduler 140, and performs, when the interrupt signal is monitored, processing corresponding to the monitored interrupt signal. As described above, the interrupt signals include a variety of types, respectively indicating different events. The monitoring response module of the one or more masters 120 performs corresponding processing based on the monitored interrupt signal, such as issuing an instruction to fix a corresponding error, issuing a readback request, or issuing an instruction to retransmit data.

According to the data scheduling system 100 in the above embodiments, the master 120 monitors the operation of the configured data scheduler 140, that is, monitors a data scheduling process, which can promptly detect and handle situations occurring in the data scheduling process, and control an overall scheduling process, thereby improving the reliability of the data scheduling system 100.

In some embodiments, the interrupt monitoring sub-circuit 149 is further configured to: determine, based on the configuration parameters, whether a priority of the generated interrupt signal is higher than a predetermined priority; report, in response to the priority of the generated interrupt signal being higher than the predetermined priority, the generated interrupt signal to the one or more masters; and clear, in response to the priority of the generated interrupt signal being no higher than the predetermined priority, the generated interrupt signal without reporting the interrupt signal to the one or more masters.

The configuration parameters may include parameters that assign a corresponding interrupt priority for each interrupt signal. Lower priorities are assigned to types of interrupt signals that are non-critical and occur infrequently, while higher priorities are assigned to types of interrupt signals that impact the data scheduling operation of the data scheduling system 100. The interrupt monitoring sub-circuit 149 reports only interrupt signals with priorities higher than a predetermined priority to the one or more masters 120 in real time. For an interrupt signal with a priority below the predetermined priority, the interrupt signal is automatically cleared and not reported to the one or more masters 120. In this case, the interrupt monitoring sub-circuit 149 may record a number of times an interrupt signal is generated and the generated interrupt signal is cleared (for example, a counter in the configured data scheduler 140 may record the number of times the interrupt signal is cleared), and record information related to the cleared interrupt signal in the memory. Upon completion of transmission of all the transmission data and effective transmission of all the transmission data, the interrupt monitoring sub-circuit 149 subsequently reports historical error interrupt signals to the master 120, so that the master 120 queries the corresponding counter and memory to learn about historical errors and optionally performs corresponding processing.

According to the data scheduling system 100 in the above embodiments, an automatic handling mechanism for interrupt signal generation is added to the side of the configured data scheduler 140, which reduces software scheduling pressure on the side of the master 120 and improves data scheduling efficiency of the data scheduling system 100.

In some embodiments, the configured data scheduler 140 further includes: a security check sub-circuit configured to determine a circuit structure thereof based on the configuration parameters, and check, based on the determined circuit structure, whether an error occurs during operation of the configured data scheduler 140. The interrupt monitoring sub-circuit 149 is further configured to generate, in response to monitoring that an error occurs during the operation of the configured data scheduler 140, an interrupt signal and report the interrupt signal to the one or more masters 120.

The configured data scheduler 140 may include a security check sub-circuit configured to implement various check functions, distributed across various parts of the configured data scheduler 140. For example, the configured data scheduler 140 may include a data check sub-circuit 147 connected to the data scheduling sub-circuit 146 and configured to receive transmission data scheduled by the data scheduling sub-circuit 146 and check the correctness of the transmission data before being sent to the slave. The configured data scheduler 140 may include a register security check sub-circuit arranged in the parameter configuration sub-circuit 145 and configured to check register parity errors in the parameter configuration sub-circuit 145. The configured data scheduler 140 may include a memory security check sub-circuit arranged in the transmission buffer sub-circuit 144 and configured to self-check storage errors inside the transmission buffer sub-circuit 144. The security check sub-circuit determines a circuit structure thereof based on the configuration parameters, specifically involving which security check sub-circuits are included or enabled, thereby determining specific check functions that are implemented.

The interrupt monitoring sub-circuit 149 monitors an operation result of the security check sub-circuit. When the operation result of the security check sub-circuit indicates that an error occurs in the data scheduler during the operation, an interrupt signal is generated in real time and reported to the one or more masters 120. When receiving an interrupt signal indicating an operation error in the configured data scheduler 140, the one or more masters 120 may issue an instruction to fix the corresponding error, such as reconfiguring or resetting the malfunctioning sub-circuit, or resending the transmission data.

According to the data scheduling system 100 in the above embodiments, the security check sub-circuit determines the circuit structure thereof based on the configuration parameters, and can determine, based on settings of the master 120, specific check functions that are implemented. The configured data scheduler 140 includes a corresponding security check mechanism according to an actual requirement of a communication scenario, which can ensure the security of data transmission. In addition, the master 120 can learn about in real time whether an error occurs during the operation of the configured data scheduler 140 and perform corresponding processing in a timely manner.

In some embodiments, the security check sub-circuit includes a data check sub-circuit 147 configured to determine a data check algorithm based on the configuration parameters, and check, based on the determined data check algorithm, whether an error occurs during transmission of the transmission data. The interrupt monitoring sub-circuit 149 is further configured to generate, in response to monitoring that an error occurs during the transmission of the transmission data, an interrupt signal and report the interrupt signal to the one or more masters.

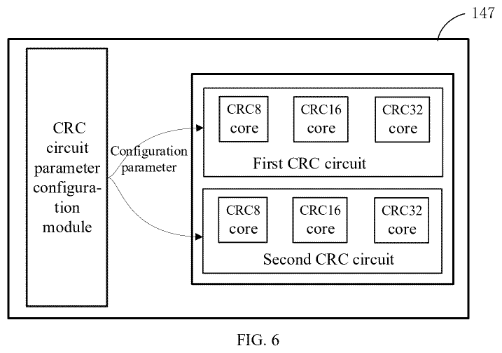

FIG. 6 is a schematic block diagram of configuration of the data check sub-circuit 147 according to embodiments of the present disclosure. The data check sub-circuit 147 is connected to the data scheduling sub-circuit 146, receives transmission data scheduled by the data scheduling sub-circuit 146, and verifies the received transmission data.

The data check sub-circuit 147 is, for example, a cyclic redundancy check (CRC) check circuit, with cores configured to implement a plurality of CRC algorithms preset therein, such as a CRC8 core, a CRC16 core, and a CRC32 core respectively used to execute CRC8, CRC16, and CRC32 algorithms. The configuration parameters determined by the master 120 are applied to a CRC circuit parameter configuration module of the data check sub-circuit 147, thereby determining which CRC core inside the data check sub-circuit 147 is specifically enabled to execute the corresponding CRC algorithm.

Further, the CRC circuit parameter configuration module of the data check sub-circuit 147 further determines an actual operating circuit structure based on the configuration parameters. For example, the data check sub-circuit 147 may include a first CRC circuit and a second CRC circuit. During actual operation, the first CRC circuit and the second CRC circuit may implement the same CRC algorithm, that is, each uses the corresponding CRC core, has a same hardware circuit structure, and receives the same transmission data as input and performs data check respectively. Upon completion of check, a dedicated comparison circuit is provided to compare whether output results of the two circuits are consistent, thereby improving the accuracy of check of the transmission data by the data check sub-circuit 147. This is called a lockstep mechanism. In this case, the data check sub-circuit 147 further determines, based on the configuration parameters, whether to enable the lockstep mechanism, that is, whether to enable the first CRC circuit and the second CRC circuit simultaneously.

A check result of the data check sub-circuit 147 indicates whether an error occurs in the transmission data during the transmission. The interrupt monitoring sub-circuit 149 monitors a data check result of the data check sub-circuit 147, and generates, when monitoring that an error occurs in the transmission data during the transmission, an interrupt signal in real time and reports the interrupt signal to the one or more masters 120. The one or more masters 120 may learn, based on the received interrupt signal, that an error occurs in the transmission data during the transmission. In response, the master 120 may resend the data in which an error occurs during the transmission.

According to the data scheduling system 100 in the above embodiments, the security check sub-circuit includes a data check sub-circuit 147. A check algorithm and an actual operating circuit structure of the data check sub-circuit 147 are determined and non-volatilely programmed based on the configuration parameters determined by the master 120. The configured data scheduler 140 includes a corresponding data check mechanism according to an actual requirement of a communication scenario, which can ensure the security of data transmission. In addition, the master 120 can learn about in real time whether a data transmission error occurs during the data scheduling of the configured data scheduler 140 and perform corresponding processing in a timely manner.

In some embodiments, the transmission buffer sub-circuit is further configured to disable, when a capacity of the transmission data buffered in the transmission buffer sub-circuit 144 reaches a predetermined threshold set based on the configuration parameters, a receiving channel for receiving the transmission data from the data receiving sub-circuit 142. The interrupt monitoring sub-circuit 149 is further configured to generate, in response to monitoring that the capacity of the transmission data buffered in the transmission buffer sub-circuit 144 reaches the predetermined threshold, the interrupt signal and report the interrupt signal to the one or more masters 120.

The one or more masters 120 may set a predetermined capacity threshold for each transmission storage part in the transmission buffer sub-circuit 144, and then apply the predetermined threshold to the configured data scheduler 140 through the configuration parameters. For example, the predetermined threshold may be 70% of a total capacity of each transmission storage part or 80% of the total capacity of each transmission storage part, which is determined by the master 120 based on an actual communication scenario. If the master 120 continuously and rapidly inputs the transmission data to the configured data scheduler 140 without control, new transmission data may be lost once a capacity of the transmission buffer sub-circuit 144 is full, which may lead to maloperation or data errors in the entire system. In the present disclosure, during data transmission, when a capacity of the transmission data buffered in any transmission storage part of the transmission buffer sub-circuit 144 reaches the predetermined threshold, the receiving channel for receiving transmission data from the data receiving sub-circuit 142 is disabled, so that subsequent transmission data can no longer be transmitted into the transmission buffer sub-circuit 144. When the capacity of the transmission data buffered in the transmission buffer sub-circuit 144 drops below the predetermined threshold after the buffered transmission data is scheduled, the receiving channel for receiving transmission data from the data receiving sub-circuit 142 is re-enabled. Enabling and disabling of the receiving channel control whether new transmission data is allowed to enter the transmission buffer sub-circuit 144.

The interrupt monitoring sub-circuit 149 monitors whether the capacity of the transmission data buffered in transmission buffer sub-circuit 144 reaches the predetermined threshold. When the predetermined threshold is reached, an interrupt signal is generated in real time and reported to the one or more masters 120. Regarding this, the one or more masters 120 may learn about that a current data scheduling capability of the configured data scheduler 140 is limited, thereby reducing a sending rate of the transmission data or pausing sending of the transmission data, to prevent data omission or loss.

According to the data scheduling system 100 in the above embodiments, the predetermined threshold of the capacity of the transmission buffer sub-circuit 144 may be set according to a requirement of a communication scenario, and a backpressure mechanism is provided to disable a data receiving channel and notify the master 120 when the capacity reaches the threshold. Through the backpressure mechanism, a balance between data input and an internal processing speed of the data scheduling system 100 can be reached, ensuring system stability and data integrity. Since the backpressure mechanism is based on the configuration parameters determined by the master 120 according to the communication scenario, the master 120 can flexibly control data input and scheduling rhythms according to an actual communication scenario, which improves adaptability of the system to different data traffic and processing tasks, thereby enhancing performance and reliability of the entire system.

In some embodiments, the transmission data includes a master identifier, a slave identifier, and a data content part adapted to a type of the slave 160, the transmission buffer sub-circuit 144 buffers, based on the slave identifier of the transmission data, the transmission data into the transmission storage part corresponding to the slave identifier, and the readback buffer sub-circuit 148 buffers, based on the master identifier of the transmission data, readback data corresponding to the transmission data into the readback storage part corresponding to the master identifier.

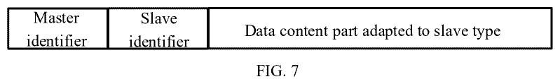

FIG. 7 is a schematic diagram of a data format of transmission data according to embodiments of the present disclosure. The data content part adapted to the type of the slave is valid data content to be sent to the slave 160, which has a data format adapted to the slave 160, and more specifically, has a data format supported by a physical interface connecting the slave 160 to the configured data scheduler 140. For example, when the slave 160 is a device connected through an I2C interface, the data content part adapted to content of the slave is in a data format specified by the I2C protocol. When the slave 160 is a device connected through an SPI interface, the data content part adapted to the content of the slave is in a data format supported by SPI.

On the basis of the data content part adapted to the type of the slave 160, a master identifier and a slave identifier are added to the data format of the transmission data of the data scheduling system 100 according to the present disclosure. The master identifier is used to identify a flag bit of the master 120 from which the transmission data is originated, and the slave identifier is used to identify a flag bit of the slave 160 (destination) to which the transmission data is to be transmitted.

Data bit widths of the master identifier and the slave identifier are determined by the master 120 based on an actual communication scenario, and more specifically, based on a number of the masters and a number of the slaves in the data scheduling system 100. Specifically, when N masters 120 are provided, the data width of the master identifier may be determined by rounding up log₂(N). When M slaves 160 are provided, the data width of the master identifier may be determined by rounding up log₂(M). For example, when the data scheduling system 100 includes three masters 120 and five slaves 160 for communication, log₂(3)≈1.58. However, since a number of bits must be an integer, it is rounded up to 2 bits. The 2 bits can represent 4 states: 00, 01, 10, and 11, which is sufficient to distinguish the three masters 120. log₂(5)≈2.32, rounded up to 3 bits, and the 3 bits can represent 8 states: 000, 001, 010, 011, 100, and the like, which is sufficient to distinguish the five slaves 160.

Before starting data transmission, the master 120 organizes the transmission data into the above data format and then sends the transmission data to the configured data scheduler 140.

After the transmission data enters the configured data scheduler 140, the transmission buffer sub-circuit 144 buffers, based on the slave identifier of the transmission data, the transmission data into the transmission storage part corresponding to the slave identifier. As described above, the transmission buffer sub-circuit 144 includes one or more transmission storage parts in one-to-one correspondence to the one or more slaves 160. The transmission storage parts are classified according to slave identifiers. The configured data scheduler 140 determines, based on the slave identifier in the transmission data, the transmission storage part in which the transmission data should be buffered.

The readback data is sent based on the transmission data. Therefore, there is a corresponding relationship between the readback data and the transmission data. As described above, the readback buffer sub-circuit 148 includes one or more readback storage parts in one-to-one correspondence to the one or more masters 120. The slave 160 generates readback data based on the received transmission data. The readback data is buffered in the readback storage part in the readback buffer sub-circuit 148 corresponding to the master identifier, according to the master identifier of the transmission data corresponding thereto.

In short, the master identifier is used to select the transmission storage part in the transmission buffer sub-circuit 144, while the slave identifier is used to select the readback storage part in the readback buffer sub-circuit 148.

The data scheduling system 100 according to the above embodiments can be easily applied to communication of transmission data from multiple masters to multiple slaves and can be applied to various types of slave devices. The transmission data and the readback data can be correctly and efficiently scheduled by the configured data scheduler 140 only by adding the master identifier and the slave identifier before the data content part adapted to the type of the slave.

In some embodiments, the transmission data includes a fast transmission flag bit and a priority flag bit, and the configured data scheduler 140 determines, based on the fast transmission flag bit, whether to cause the data scheduling sub-circuit 146 to directly acquire the transmission data received by the data receiving sub-circuit 142, without transmitting the transmission data through the transmission buffer sub-circuit 144. The data scheduling sub-circuit 146 is further configured to determine, based on the priority flag bit, a priority order of transmission of the transmission data to the slaves 160.

The fast transmission flag bit and the priority flag bit may be located in the data content part adapted to the type of the slave. The fast transmission flag bit may have a 1-bit width, and is used to indicate whether the transmission data belongs to fast transmission data. The fast transmission data is data having the highest priority and required to be fastest transmitted to the slave 160, such as an instruction to reset the slave 160 when an error occurs in the slave 160. If the fast transmission flag bit indicates that the data belongs to fast transmission data, the configured data scheduler 140 causes the data scheduling sub-circuit 146 to directly acquire the transmission data received by the data receiving sub-circuit 142. The transmission data is directly scheduled to the slave 160 without passing through the transmission buffer sub-circuit 144. Therefore, the fast transmission data can be fast transmitted to the slave 160 without being buffered by the transmission buffer sub-circuit 144 and without arbitration by the input arbitration sub-circuit.

The priority flag bit may have a 2-bit width, and is used to identify priorities of the transmission data. The data scheduling sub-circuit 146 determines a sending order of the transmission data based on the priorities of the transmission data. Furthermore, the input arbitration sub-circuit described above may also determine, based on the priorities of the transmission data, a priority order in which the transmission data is sent to the transmission buffer sub-circuit 144.

Furthermore, the master 120 may set the priority flag bit in the transmission data based on a communication scenario. That is, the master 120 may arrange a priority order of sending the transmission data according to the communication scenario, which prevents conflicts between an order in which the slave 160 receives the transmission data and logic of the received transmission data. More specifically, the master 120 sets the priorities of the transmission data according to operation logic of the slave 160. For example, when the operation logic of the slave 160 first requires transmission data A and then requires transmission data B, the master 120 may set a priority of the transmission data A to be higher than that of the transmission data B. Therefore, the master 120 can address the problem of data conflicts at a software level.

The data scheduling system 100 according to the above embodiments can schedule the transmission data efficiently according to an actual requirement.

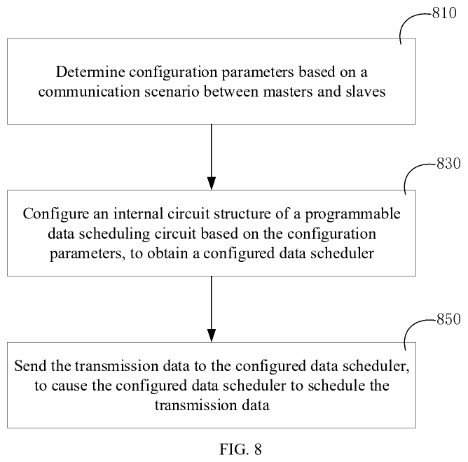

In another aspect of the present disclosure, a data scheduling method is provided, for example, applied to the master in the data scheduling system above. FIG. 8 is a flowchart of a data scheduling method according to embodiments of the present disclosure. As shown in FIG. 8, the data scheduling method includes:

In S810, configuration parameters are determined based on a communication scenario between masters and slaves.

In S830, an internal circuit structure of a programmable data scheduling circuit is configured based on the configuration parameters, to obtain a configured data scheduler.

In S850, the transmission data is sent to the configured data scheduler, to cause the configured data scheduler to schedule (e.g., send) the transmission data.

In some embodiments, the data scheduling method further includes: monitoring a predetermined event occurring during the scheduling of the transmission data by the configured data scheduler, and performing, in response to the monitoring of the predetermined event, processing corresponding to the predetermined event.

In some embodiments, the data scheduling method further includes: resetting the configured data scheduler in response to completion of scheduling of the transmission data by the configured data scheduler.

“Completion of scheduling” refers to effective scheduling of all the transmission data, which means that all the transmission data is sent into the configured data scheduler, and all the transmission data sent into the configured data scheduler is scheduled (e.g., sent) to the corresponding slaves without any residue inside the configured data scheduler. All data read back from the slaves is received, and data check of the transmission data is correct. “Reset” refers to restoring the configured data scheduler to a default state, e.g., removing programmed configuration parameters thereof and restoring to a state of the programmable data scheduling circuit.

Specifically, the data scheduling method further includes: monitoring whether all the transmission data enters the configured data scheduler, continuously waiting for, in response to not all the transmission data being sent into the configured data scheduler, sending the transmission data, monitoring, in response to all the transmission data being sent into the configured data scheduler, whether there is any residual transmission data in the configured data scheduler, continuously waiting for, in response to the monitoring of residual transmission data in the configured data scheduler, transmitting the transmission data, monitoring, in response to the monitoring of no residual transmission data in the configured data scheduler, whether all requested readback data from the slave is received, continuously waiting for, in response to not all the requested readback data from the slave being received, receiving the readback data from the slave, and resetting the configured data scheduler in response to all the requested readback data from the slave being received, and restoring the readback data to the state of the programmable data scheduling circuit.

In some embodiments, the configured data scheduler includes: a data receiving sub-circuit including, based on the configuration parameters, one or more data receiving parts respectively corresponding to the one or more masters, each data receiving part receiving the transmission data from the corresponding master, a transmission buffer sub-circuit including, based on the configuration parameters, one or more transmission storage parts respectively corresponding to the one or more slaves, and configured to buffer the transmission data received from the data receiving sub-circuit into the transmission storage part corresponding to the slave to which the transmission data is to be transmitted, sizes of the one or more transmission storage parts being configured based on traffic volumes of transmission data from different masters to different slaves, and a data scheduling sub-circuit configured to schedule (e.g., send), according to a predetermined rule set based on the configuration parameters, the transmission data buffered in each of the transmission storage parts of the transmission buffer sub-circuit to the slave corresponding to the transmission storage part.

In some embodiments, the configured data scheduler further includes: a readback buffer sub-circuit including, based on the configuration parameters, one or more readback storage parts respectively corresponding to the one or more masters. Each readback storage part is configured to buffer readback data to be sent to the master corresponding to the readback storage part by the slave in response to receiving the transmission data. Sizes of the one or more readback storage parts are configured based on traffic volumes of readback data from different slaves to different masters.

In some embodiments, the configured data scheduler further includes: an interrupt monitoring sub-circuit configured to monitor events occurring during the scheduling of the transmission data by the configured data scheduler, and generate, in response to monitoring a predetermined event, an interrupt signal and report the interrupt signal to the one or more masters, and the data scheduling method further includes: monitoring the interrupt signal reported by the interrupt monitoring sub-circuit of the configured data scheduler, and performing, when the interrupt signal is monitored, processing corresponding to the monitored interrupt signal.

In some embodiments, the interrupt monitoring sub-circuit is further configured to: determine, based on the configuration parameters, whether an interrupt priority of the generated interrupt signal is higher than a predetermined priority, report, in response to the interrupt priority of the generated interrupt signal being higher than the predetermined priority, the generated interrupt signal to the one or more masters, and clear, in response to the interrupt priority of the generated interrupt signal being no higher than the predetermined priority, the generated interrupt signal without reporting the interrupt signal to the one or more masters.

In some embodiments, the configured data scheduler further includes: a security check sub-circuit configured to determine a circuit structure thereof based on the configuration parameters, and check, based on the determined circuit structure, whether an error occurs during operation of the configured data scheduler. The interrupt monitoring sub-circuit is further configured to generate, in response to monitoring that an error occurs during the operation of the configured data scheduler, an interrupt signal and report the interrupt signal to the one or more masters.

In some embodiments, the security check sub-circuit includes a data check sub-circuit configured to determine a data check algorithm based on the configuration parameters, and check, based on the determined data check algorithm, whether an error occurs during transmission of the transmission data. The interrupt monitoring sub-circuit is further configured to generate, in response to monitoring that an error occurs during the transmission of the transmission data, an interrupt signal and report the interrupt signal to the one or more masters.

In some embodiments, the transmission buffer sub-circuit is further configured to disable, when a capacity of the transmission data buffered in the transmission buffer sub-circuit reaches a predetermined threshold set based on the configuration parameters, a receiving channel for receiving the transmission data from the data receiving sub-circuit. The interrupt monitoring sub-circuit is further configured to generate, in response to monitoring that the capacity of the transmission data buffered in the transmission buffer sub-circuit reaches the predetermined threshold, the interrupt signal and report the interrupt signal to the one or more masters.

In some embodiments, the data scheduling method further includes: organizing the transmission data into a format including a master identifier, a slave identifier, and a data content part adapted to a type of the slave. The transmission buffer sub-circuit buffers, based on the slave identifier of the transmission data, the transmission data into the transmission storage part corresponding to the slave identifier. The readback buffer sub-circuit buffers, based on the master identifier of the transmission data, readback data corresponding to the transmission data into the readback storage part corresponding to the master identifier.

In some embodiments, the transmission data includes a fast transmission flag bit and a priority flag bit, and the configured data scheduler determines, based on the fast transmission flag bit, whether to cause the data scheduling sub-circuit to directly acquire the transmission data received by the data receiving sub-circuit, without passing through the transmission buffer sub-circuit. The data scheduling sub-circuit is further configured to determine, based on the priority flag bit, a priority order of transmission of the transmission data to the slaves.

For details of the data scheduling method according to the present disclosure, please refer to the above description of the data scheduling system according to the present disclosure. Details are not described herein again.

In another aspect of the present disclosure, a non-transitory computer-readable storage medium is provided, having a computer program stored therein. When the computer program is executed by a processor, the data scheduling method according to the present disclosure is implemented.

For details of the non-transitory computer-readable storage medium according to the present disclosure, please refer to the above description of the data scheduling system according to the present disclosure. Details are not described herein again.

In another aspect of the present disclosure, a computer program product is provided, including a computer program. When the computer program is executed by a processor, the data scheduling method according to the present disclosure is implemented.

For details of the computer program product according to the present disclosure, please refer to the above description of the data scheduling system according to the present disclosure. Details are not described herein again.

The technical features in the above embodiments may be randomly combined. For concise description, not all possible combinations of the technical features in the above embodiments are described. However, all the combinations of the technical features are to be considered as falling within the scope described in this specification provided that they do not conflict with each other.

The above embodiments only describe several example implementations of the present invention, and their description is specific and detailed, but cannot therefore be understood as a limitation on the patent scope of the invention. It should be noted that those of ordinary skill in the art may further make variations and improvements without departing from the conception of the present invention, and these all fall within the protection scope of the present invention. Therefore, the patent protection scope of the present invention should be subject to the appended claims.

1. A data scheduling system, comprising:
one or more masters configured to determine configuration parameters based on a communication scenario and to generate transmission data;
a programmable data scheduling circuit configured to receive the configuration parameters and configure an internal circuit structure of the programmable data scheduling circuit based on the configuration parameters, for obtaining a configured data scheduler, the configured data scheduler receiving the transmission data; and
one or more slaves configured to receive the transmission data scheduled by the configured data scheduler.

2. The data scheduling system according to claim 1, wherein the configured data scheduler comprises:
a data receiving sub-circuit comprising, based on the configuration parameters, one or more data receiving parts respectively corresponding to the one or more masters, each of the data receiving parts receiving the transmission data from the corresponding master;
a transmission buffer sub-circuit comprising, based on the configuration parameters, one or more transmission storage parts respectively corresponding to the one or more slaves, and configured to buffer the transmission data received from the data receiving sub-circuit into the transmission storage part corresponding to the slave to which the transmission data is to be transmitted, sizes of the one or more transmission storage parts being configured based on traffic volumes of transmission data from different masters to different slaves; and
a data scheduling sub-circuit configured to schedule, according to a predetermined rule set based on the configuration parameters, the transmission data buffered in each of the transmission storage parts of the transmission buffer sub-circuit to the slave corresponding to the transmission storage part.

3. The data scheduling system according to claim 1, wherein the configured data scheduler further comprises:
a readback buffer sub-circuit comprising, based on the configuration parameters, one or more readback storage parts respectively corresponding to the one or more masters, each of the readback storage parts being configured to buffer readback data to be sent to the master corresponding to the readback storage part by the slave in response to receiving the transmission data;
wherein sizes of the one or more readback storage parts are configured based on traffic volumes of readback data from different slaves to different masters.

4. The data scheduling system according to claim 1, wherein
the configured data scheduler further comprises: an interrupt monitoring sub-circuit configured to monitor events occurring during the scheduling of the transmission data by the configured data scheduler, and generate, in response to monitoring a predetermined event, an interrupt signal and report the generated interrupt signal to the one or more masters; and
the one or more masters comprise a monitoring response module configured to monitor the generated interrupt signal reported by the interrupt monitoring sub-circuit of the configured data scheduler, and perform operations corresponding to the generated interrupt signal.

5. The data scheduling system according to claim 4, wherein the interrupt monitoring sub-circuit is further configured to:
determine, based on the configuration parameters, whether an interrupt priority of the generated interrupt signal is higher than a predetermined priority;
report, in response to determining that the interrupt priority of the generated interrupt signal is higher than the predetermined priority, the generated interrupt signal to the one or more masters; or
clear, in response to determining that the interrupt priority of the generated interrupt signal is not higher than the predetermined priority, the generated interrupt signal without reporting the interrupt signal to the one or more masters.

6. The data scheduling system according to claim 4, wherein
the configured data scheduler further comprises: a security check sub-circuit configured to determine a circuit structure thereof based on the configuration parameters, and check, based on the determined circuit structure, whether an error occurs during operation of the configured data scheduler; and
the interrupt monitoring sub-circuit is further configured to generate, in response to monitoring that the error occurs during the operation of the configured data scheduler, an interrupt signal and report the interrupt signal to the one or more masters.

7. The data scheduling system according to claim 6, wherein
the security check sub-circuit comprises a data check sub-circuit configured to determine a data check algorithm based on the configuration parameters, and check, based on the determined data check algorithm, whether an error occurs during transmission of the transmission data; and
the interrupt monitoring sub-circuit is further configured to generate, in response to monitoring that the error occurs during the transmission of the transmission data, an interrupt signal and report the interrupt signal to the one or more masters.

8. The data scheduling system according to claim 4, wherein
the transmission buffer sub-circuit is further configured to disable, when a capacity of the transmission data buffered in the transmission buffer sub-circuit reaches a predetermined threshold set based on the configuration parameters, a receiving channel for receiving the transmission data from the data receiving sub-circuit; and
the interrupt monitoring sub-circuit is further configured to generate, in response to monitoring that the capacity of the transmission data buffered in the transmission buffer sub-circuit reaches the predetermined threshold, the interrupt signal and report the interrupt signal to the one or more masters.

9. The data scheduling system according to claim 3, wherein the transmission data comprises a master identifier, a slave identifier, and a data content part adapted to a slave type;
the transmission buffer sub-circuit, based on the slave identifier of the transmission data, the transmission data into the transmission storage part corresponding to the slave identifier; and
the readback buffer sub-circuit, based on the master identifier of the transmission data, readback data corresponding to the transmission data into the readback storage part corresponding to the master identifier.

10. The data scheduling system according to claim 2, wherein the transmission data comprises a fast transmission flag bit and a priority flag bit;
the configured data scheduler determines, based on the fast transmission flag bit, whether to cause the data scheduling sub-circuit to directly acquire the transmission data received by the data receiving sub-circuit, without passing through the transmission buffer sub-circuit; and
the data scheduling sub-circuit is further configured to determine, based on the priority flag bit, a priority order of transmission of the transmission data to the slaves.

11. A data scheduling method, comprising:
determining, by one or more masters of a data scheduling system, configuration parameters based on a communication scenario between the one or more masters and one or more slaves of the data scheduling system;
configuring, by a programmable data scheduling circuit of the data scheduling system, an internal circuit structure of the programmable data scheduling circuit based on the configuration parameters, to obtain a configured data scheduler; and
sending, by the one or more masters, transmission data to the configured data scheduler, to cause the configured data scheduler to schedule the transmission data.

12. A non-transitory computer-readable storage medium, having a computer program stored therein, wherein when the computer program is executed by a processor, a data scheduling method is implemented, the method comprising:
determining configuration parameters based on a communication scenario between masters and slaves;
configuring an internal circuit structure of a programmable data scheduling circuit based on the configuration parameters, to obtain a configured data scheduler; and
sending transmission data to the configured data scheduler, to cause the configured data scheduler to schedule the transmission data.

13. (canceled)

14. The data scheduling method according to claim 11, further comprising:
receiving, by each of one or more receiving parts of a data receiving sub-circuit in the data scheduling system that corresponds to a respective master of the one or more masters, the transmission data from the respective master;
buffering, by a transmission buffer sub-circuit of the data scheduling system, the transmission data received from the data receiving sub-circuit into a transmission storage circuit for a corresponding slave, wherein the transmission buffer sub-circuit comprises, based on the configuration parameters, one or more transmission storage parts respectively corresponding to the one or more slaves, wherein sizes of the one or more transmission storage parts being configured based on traffic volumes of transmission data from different masters to different slaves; and
scheduling, by a data scheduling sub-circuit of the data scheduling system and according to a predetermined rule set based on the configuration parameters, the transmission data buffered in each of the transmission storage parts of the transmission buffer sub-circuit to the slave corresponding to the transmission storage part.

15. The data scheduling method according to claim 11, wherein the configured data scheduler further comprises:
a readback buffer sub-circuit comprising, based on the configuration parameters, one or more readback storage parts respectively corresponding to the one or more masters, each of the readback storage parts being configured to buffer readback data to be sent to the master corresponding to the readback storage part by the slave in response to receiving the transmission data;
wherein sizes of the one or more readback storage parts are configured based on traffic volumes of readback data from different slaves to different masters.

16. The data scheduling method according to claim 11, wherein the configured data scheduler further comprises:
an interrupt monitoring sub-circuit configured to monitor events occurring during the scheduling of the transmission data by the configured data scheduler, and generate, in response to monitoring a predetermined event, an interrupt signal and report the generated interrupt signal to the one or more masters; and
the one or more masters comprise a monitoring response module configured to monitor the generated interrupt signal reported by the interrupt monitoring sub-circuit of the configured data scheduler, and perform operations corresponding to the generated interrupt signal.

17. The data scheduling method according to claim 16, further comprising:
determining, by the interrupt monitoring sub-circuit, based on the configuration parameters, whether an interrupt priority of the generated interrupt signal is higher than a predetermined priority;
reporting, by the interrupt monitoring sub-circuit and in response to determining that the interrupt priority of the generated interrupt signal is higher than the predetermined priority, the generated interrupt signal to the one or more masters; or
clearing, by the interrupt monitoring sub-circuit and in response to determining that the interrupt priority of the generated interrupt signal is not higher than the predetermined priority, the generated interrupt signal without reporting the interrupt signal to the one or more masters.

18. The non-transitory computer-readable storage medium according to claim 12, further comprising:
receiving, by each of one or more receiving parts of a data receiving sub-circuit of the data scheduling system that corresponds to a respective master of the one or more masters, the transmission data from the respective master;
buffering, by a transmission buffer sub-circuit of the data scheduling system, the transmission data received from the data receiving sub-circuit into a transmission storage circuit for a corresponding slave, wherein the transmission buffer sub-circuit comprises, based on the configuration parameters, one or more transmission storage parts respectively corresponding to the one or more slaves, wherein sizes of the one or more transmission storage parts being configured based on traffic volumes of transmission data from different masters to different slaves; and
scheduling, by a data scheduling sub-circuit of the data scheduling system and according to a predetermined rule set based on the configuration parameters, the transmission data buffered in each of the transmission storage parts of the transmission buffer sub-circuit to the slave corresponding to the transmission storage part.

19. The non-transitory computer-readable storage medium according to claim 12, wherein the configured data scheduler further comprises:
a readback buffer sub-circuit comprising, based on the configuration parameters, one or more readback storage parts respectively corresponding to the one or more masters, each of the readback storage parts being configured to buffer readback data to be sent to the master corresponding to the readback storage part by the slave in response to receiving the transmission data;
wherein sizes of the one or more readback storage parts are configured based on traffic volumes of readback data from different slaves to different masters.

20. The non-transitory computer-readable storage medium according to claim 12, wherein the configured data scheduler further comprises:
an interrupt monitoring sub-circuit configured to monitor events occurring during the scheduling of the transmission data by the configured data scheduler, and generate, in response to monitoring a predetermined event, an interrupt signal and report the generated interrupt signal to the one or more masters; and
the one or more masters comprise a monitoring response module configured to monitor the generated interrupt signal reported by the interrupt monitoring sub-circuit of the configured data scheduler, and perform operations corresponding to the generated interrupt signal.

21. The non-transitory computer-readable storage medium according to claim 20, further comprising:
determining, by the interrupt monitoring sub-circuit, based on the configuration parameters, whether an interrupt priority of the generated interrupt signal is higher than a predetermined priority;
reporting, by the interrupt monitoring sub-circuit and in response to determining that the interrupt priority of the generated interrupt signal is higher than the predetermined priority, the generated interrupt signal to the one or more masters; or
clearing, by the interrupt monitoring sub-circuit and in response to determining that the interrupt priority of the generated interrupt signal is not higher than the predetermined priority, the generated interrupt signal without reporting the interrupt signal to the one or more masters.
